(19) United States
(12) Patent Application Publication
(10) Pub. No.: US 2011/0170532 A1
(43) Pub. Date: Jul. 14, 2011

(54) DISTRIBUTION OF AN AUTHENTICATION FUNCTION IN A MOBILE NETWORK

(75) Inventors: Christian Tchepnda, Issy Les Moulineaux (FR); Hassnaa Moustafa, Boulogne Billancourt (FR)

(73) Assignee: France Telecom, Paris (FR)

(21) Appl. No.: 13/120,686

(22) PCT Filed: Sep. 15, 2009
(86) PCT No.: PCT/FR2009/051725

§ 371 Date: Mar. 24, 2011

(30) Foreign Application Priority Data
Sep. 26, 2008 (FR) 0856508

(51) Int. Cl. H04W 4/00

(52) U.S. Cl. 370/338

(57) ABSTRACT

A mobile terminal is authenticated in a packet transmission mobile network comprising an access network responsible for authenticating said mobile terminal and an access point to said access network. A counter indicating the number of authentication requests already received is managed. At the access network level, an authentication request is received from the mobile terminal. Then the counter is incremented by one. Then the mobile terminal is authenticated, the number indicated by the counter is compared with a threshold value, and, on the basis of that comparison, it is decided whether to authorize the authenticated mobile terminal to assume the role of the access network to authenticate another mobile terminal.

The present invention relates to mobile communications networks, such as vehicular networks in particular, and especially to the stage of authenticating a mobile terminal in such a network.

Vehicular networks offer a wide range of services to vehicle drivers and passengers, such as services linked to road safety and cooperative driving in particular, thus making it possible to report a collision, or even a fire, or landslide, if any. Such networks also make it possible to offer Internet browsing services for on-line games or for discovering services offered within a geographical area being passed through.

In a standard Dedicated Short-Range Communications (DSRC) vehicular network architecture, a stage of authentication of the user precedes access to a service offered by the vehicular network.

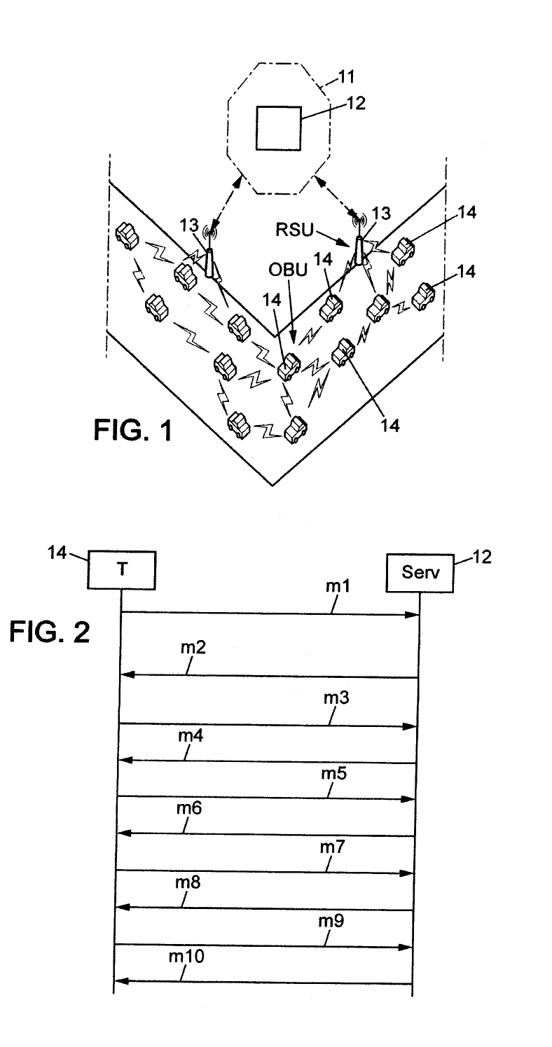

FIG. 1 shows one such vehicular network architecture. A network of this kind includes an access network 11 through which a vehicular network user may access services. It further includes fixed network equipments 13 known as road-side units (RSU) and mobile equipments 14, here on board the vehicles and known as on-board units (OBU).

The access network 11 includes an authentication server 12 responsible for authenticating an OBU 14 requesting access to a service of the network concerned. This kind of authentication step makes it possible to manage access to resources and to services offered in the network on the basis of access rights of the OBUs.

The proposed architecture shown in FIG. 1 is a hybrid ad hoc network architecture in which vehicles or OBUs communicate with the fixed infrastructure and notably with the authentication server during the authentication stage via the access points or RSUs.

Communication between a mobile vehicle OBU 14 and an access point RSU 13 may be either direct between the OBU and the RSU or via one or more OBU hops. A vehicle in the coverage area of an access point or RSU is able to communicate directly with that RSU, whereas a vehicle that is outside the coverage area of that RSU cannot communicate directly with that RSU but can communicate with it via an OBU, or a plurality of OBUs, a hop consisting of a link between two OBUs. When linking via OBUs, the OBUs used for the hops are responsible for forwarding the call between another OBU 14 and the access point or RSU 13.

Providing authentication via OBU to OBU hops enables OBUs not in the coverage area of the access points or RSUs to be authenticated by the authentication server and to access any services of the network that may be available outside the coverage area of the RSUs. This kind of authentication makes it possible to deploy the access points or RSUs efficiently, given that it would be particularly costly to make it possible for all OBUs to be situated in a coverage area of an access point or an RSU.

However, in that kind of architecture, authentication deteriorates in a manner that increases with vehicle or OBU density. Thus as soon as vehicle density is high, data traffic in the network becomes high, the number of multi-hop communications links increases, and authentication failures multiply. That degrades quality of service and continuity of service.

The present invention aims to improve on that situation.

A first aspect of the present invention provides a method of authenticating at least one mobile terminal in a packet transmission mobile network including an access network responsible for authenticating said mobile terminal, at least one access point to said access network, and a counter for indicating a number of authentication requests already received, said method including the following steps executed in said access network:

1) receiving an authentication request from said mobile terminal;

2) incrementing the counter by 1; and

3) authenticating the mobile terminal, comparing the number indicated by the counter with a threshold value, and, on the basis of said comparison, deciding to authorize the authenticated mobile terminal to assume the role of the access network to authenticate at least one other mobile terminal.

This approach makes it possible to distribute the implementation of a mobile terminal authentication step under certain conditions, i.e. if the number of authentication requests received as indicated by the counter exceeds a threshold value. Thus it is possible to delegate the execution of an authentication step to a mobile terminal that has been authenticated as soon as the number of authentication requests received at the access network level is considered too high.

By distributing authentication in this way to authorize mobile terminals to access the resources of the network, bandwidth occupation can advantageously be reduced and the quality of service offered to the mobile terminals of the network increased by preventing authentication failures. Overloading at the access network level can also be prevented.

Such characteristics may advantageously be used in any type of mobile communications network and notably in highly dynamic mobile networks such as vehicular networks.

In this type of mobile network, the terminal density may vary rapidly over time. Thus the radio bandwidth of an access network may be swamped over a period of time by authentication requests from mobile terminals situated in its geographical area. In this situation, it is possible for some authentications to fail. By distributing mobile terminal authentication to the level of another mobile terminal, the bandwidth of the access network is relieved of this load and the authentications for which it is still responsible may be effected under good conditions at the access network level.

Thereafter, once a mobile terminal has been authorized to exercise the authentication server functions, it is able to authenticate all mobile terminals from which it receives an authentication request.

In a vehicular network, a mobile terminal that is not in the coverage area of an access point may send the access network an authentication request via another mobile terminal that is situated in the coverage area of an access point to the access network or itself has access to the access network via one or more other mobile terminals. This has the advantage that any mobile terminal of a network of this kind can potentially be authorized by the access network to authenticate another mobile terminal provided that it has been authenticated itself and is on the communications link between the mobile terminal that submitted the authentication request and the access network concerned. Thus as soon as a mobile terminal that is responsible for forwarding packets between another mobile terminal and the access network receives an authentication request it can check if it is authorized to authenticate that mobile terminal and, if so, authenticate it locally without forwarding the received authentication request to the access network.

This distribution of the authentication function at the level of mobile terminals of the network may advantageously be implemented flexibly so as to adapt to changes in the mobile terminal density in the geographical area concerned.

To take into account changes of density as a function of time there may be provision for observing the variations of certain parameters over a given time period.

In one implementation of the present invention, over a given time period the threshold value is determined as a function of a threshold average distance between two mobile terminals of the network and an average speed of the mobile terminals in the access network.

By taking into account in this way these two parameters, i.e. the threshold average distance between two mobile terminals and the average speed of the mobile terminals of the network, it is possible to determine a threshold value that reflects the threshold mobile terminal density in the network.

In one implementation of the present invention, the threshold value satisfies the following equation:

V_{threshold}=(D×V_{avg})/Id

where D is the given time period, V_{avg} is an average speed of the mobile terminals in the network, and Id is a threshold average distance between the mobile terminals of the network.

Thus by comparing the number of authentication requests with the threshold value obtained here, the decision to distribute authentication to a mobile terminal may be taken in a pertinent manner.

The average speed may be determined on the basis of information received from the access point or points.

One implementation of the present invention may include the following steps executed in said access point:

a) receiving a new packet from a mobile terminal; and

b) incrementing the first counter by 1 and incrementing the second counter by the speed value indicated in said new packet;

wherein the steps a) and b) are effected over the given time period, after which the number of packets indicated by the first counter and the speed value indicated by the second counter are sent to the access network.

By proceeding in this way the access network is able to calculate an average speed of the mobile terminals in the network. It suffices to divide the speed value sent by the access point by the number of packets indicated by the access point.

It is advantageous to envisage that the access network might produce this kind of average speed of mobile terminals in the network on the basis of all the information fed back in this way from the access points.

At the end of the given time period, the first and second counters may be initialized to 0. Thus information is available over defined time periods, making it possible to adapt the use of the method to the high variations in density that may arise in vehicular networks.

To manage this distribution of the authentication function dynamically and flexibly, the authentication request counter may be set to 0 after the given time period.

In one implementation of the present invention, the threshold average distance between two mobile terminals of the network satisfies the following equation:

Id_{med}=(Idₘᵢₙ₁+Idₘᵢₙ₂)/2 (3)

where Idₘᵢₙ₁ satisfies the following equation:

Idₘᵢₙ₁=R/(2)^{(2*InterAPDist-10R)/10R} (1)

where Idₘᵢₙ₂ satisfies the following equation:

Idₘᵢₙ₂=¾*R (2)

and where R is a mobile terminal transmission range; and InterAPDist is an average distance between the different access points in the network.

A mobile terminal may be authorized to exercise the authentication server functions, i.e. to authenticate another mobile terminal, for a particular period.

A second aspect of the present invention provides a method of authenticating at least one mobile terminal in a packet transmission mobile network including an access network responsible for authenticating said mobile terminal and at least one access point to said access network, said method including the following steps executed in said mobile terminal:

1) sending an authentication request to the access network; and

2) receiving an authentication message indicating parameters for assuming the role of the access network to authenticate another mobile terminal.

By means of these features, an access network is able to inform a mobile terminal of its decision to delegate authentication and provide that mobile terminal with means for effecting such authentication subsequently.

Thus this method of authentication at the level of the mobile terminal authorized to authenticate another terminal may further include the following steps:

i) receiving an authentication request from another mobile terminal of the network; and

ii) authenticating said other mobile terminal on the basis of said parameters received in the authentication message from the access network.

A third aspect of the present invention provides a server for authenticating at least one mobile terminal in a packet transmission mobile network, including means for implementing a method of the first aspect of the present invention.

A fourth aspect of the present invention provides a mobile terminal adapted to communicate in a packet transmission mobile network including an access network responsible for authenticating said mobile terminal and at least one access point to said access network, said mobile terminal including means for implementing a method of the second aspect of the present invention.

A fifth aspect of the present invention provides a system for authenticating at least one terminal in a packet transmission mobile network including an access network responsible for authenticating said mobile terminal, said authentication system including at least one authentication server according to the third aspect of the invention and an access point to the access network, the access point including:
a first counter for indicating a number of packets received;
a second counter for indicating a sum of the speeds of the mobile terminals indicated in said received packets; and
a sender unit for sending the access network the values indicated in the first and second counters at the end of a given time period.

A sixth aspect of the present invention provides a computer program including instructions for executing the method of the first aspect of the present invention when the program is executed by a processor.

Other aspects, objects, and advantages of the invention become apparent on reading the description of one of its embodiments.

The invention can also be better understood with the aid of the drawings, in which:

FIG. 1 shows a prior art vehicular network architecture;

FIG. 2 shows authentication of a mobile terminal in one implementation of the present invention;

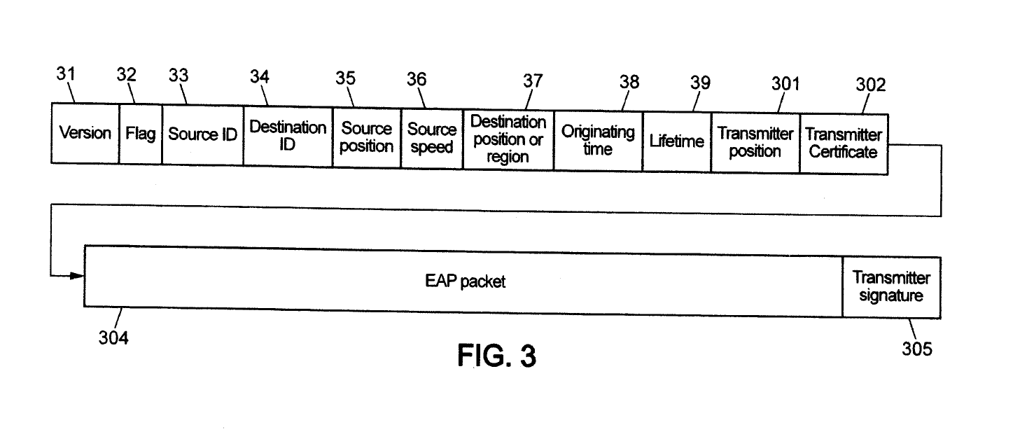

FIG. 3 shows a transport packet format used during authentication in one implementation of the present invention;

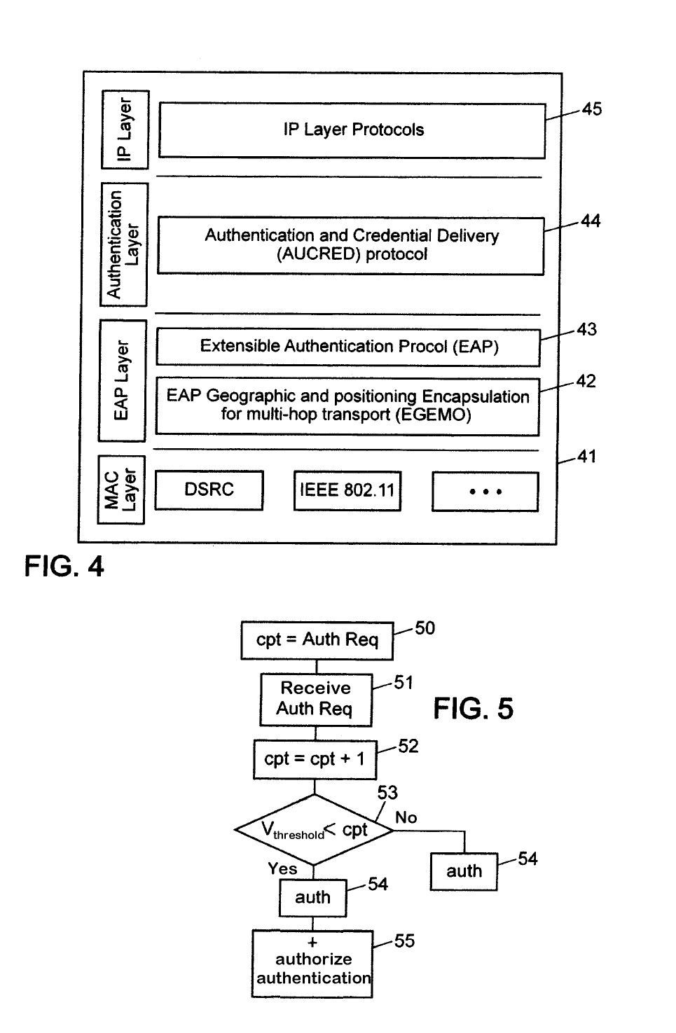

FIG. 4 shows a protocol stack used in one implementation of the present invention;

FIG. 5 shows the principal steps of an authentication method of one implementation of the present invention;

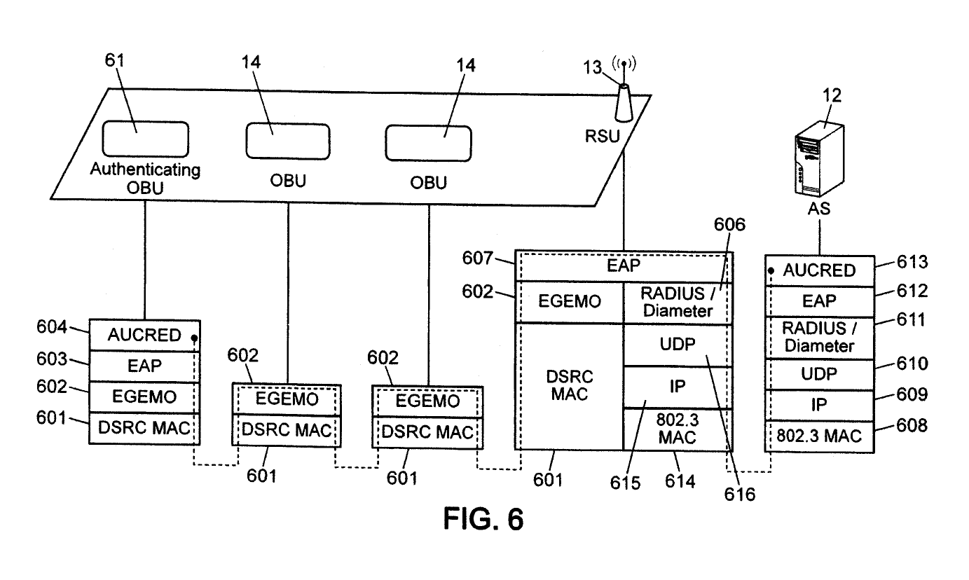

FIG. 6 shows protocol stacks used in exchanges between network entities in one implementation of the present invention; and

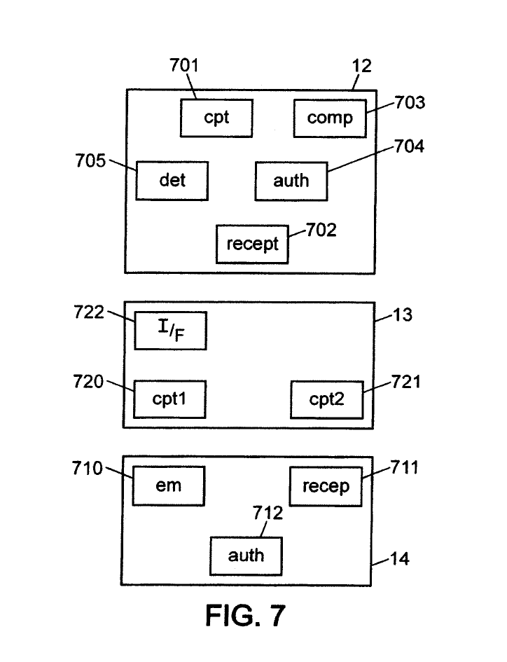

FIG. 7 shows an authentication server, an access point, and a mobile terminal of one embodiment of the present invention.

The present invention is described below in its application to the vehicular network shown in FIG. 1. The access network 11 may include one or more authentication servers 12. By way of illustration only, the access network contains only one authentication server, but it is a simple matter to adapt the description that follows to the situation in which it includes a plurality of authentication servers.

In one implementation of the present invention, the distribution of the authentication function is under the control of the authentication server.

One implementation of the present invention may use an AUCRED (AUthentication and CREdential Delivery) authentication method as described in the document ‘Performance Analysis of a Layer-2 Multi-Hop Authentication and Credential Delivery Scheme for Vehicular Networks’, C. Tchepnda et al., published in the proceedings of the VTC 2008 conference.

FIG. 2 shows an exchange of messages for carrying out authentication under an AUCRED-type protocol.

Under this kind of protocol, the mobile terminal (OBU) 14 sends the authentication server 12 a message m1 indicating to the authentication server safety parameters such as parameters relating to cryptography algorithms.

Then a cookie is exchanged between the authentication server and the mobile terminal 14 in messages m2 and m3, this cookie being intended to alleviate any Denial of Service (DoS) attacks instigated by the terminal to the detriment of the authentication server or another terminal.

A message m4 sent by the authentication server indicates the services that are offered to the mobile terminal 14. A message m5 sent by the mobile terminal 14 includes client certificates. In response, the server 12 sends a message m6 indicating parameters for a client temporary certificate, such as an identification of the client, an expiry date, a key size, cryptography algorithms, access rights, etc. This message m6 also contains the certificate of the server, associated with the private key of the server, the private key being used to sign the temporary certificate of the client.

In response, the mobile terminal sends a message m7 that indicates unsigned temporary certificates. Then, in the message m8, the server responds to the message m7 by sending back to the mobile terminal the signed temporary certificates. The mobile terminal acknowledges reception of these signed temporary certificates by means of a message m9. Finally, the authentication server sends a message m10 to close authentication.

According to the invention, in the message m6 the server indicates to the mobile terminal that it is delegating to it some of its privileges, in particular that relating to authenticating other terminals. When there is delegation, the mobile terminal to which such privileges have been delegated then serves as the authentication server to authenticate another mobile terminal. The exchanges described above take place in a similar manner.

However, in one implementation of the present invention, the mobile terminal is not authorized to delegate such privileges to a further mobile terminal. It may optionally be envisaged that a mobile terminal authorized to exercise the functions of an authentication server might be able to delegate its privileges to one or more other mobile terminals, specifying the limit number of delegations allowed.

FIG. 3 shows an EGEMO (EAP GEographic and positioning Encapsulation for Multi-hOp transport) protocol packet format as described in the document ‘Performance Analysis of a Layer-2 Multi-Hop Authentication and Credential Delivery Scheme for Vehicular Networks’ and used to transport authentication messages in one implementation of the present invention.

This kind of packet includes a field 31 indicating a version of the protocol, a field 32 indicating control information, two fields 33 and 34 indicating an identifier of the source and an identifier of the destination, a field 35 indicating the position of the source, a field 36 indicating a speed of the source, a field 37 indicating a position of the destination, a field 38 indicating an originating time reference, a field 39 indicating a lifetime, a field 301 indicating a transmitter position, a field 302 indicating a transmitter certificate, a field 304 containing an EAP (Extensible Authentication Protocol, as defined in IETF RFC 3748) packet, and a field 305 indicating a signature of the transmitter.

FIG. 4 shows a protocol stack used in exchanges between network entities in one implementation of the present invention.

This protocol stack includes a layer 41, at the level of the MAC (Medium Access Control) layer, that may correspond to different protocols depending on the implementation of the present invention. These protocols may in particular be a DSRC (Dedicated Short Range Communications) protocol in the context of vehicular networks or an IEEE 802.11 protocol in the context of WiFi networks.

This stack includes layers 42 and 43 at the level of the EAP protocol layer, the layer 42 corresponding to the EGEMO protocol layer and the layer 43 corresponding to the EAP protocol layer.

Next, an authentication protocol layer 44 corresponds to the AUCRED protocol. This protocol layer is situated below the IP protocol layer 45.

Here the AUCRED protocol is transported by the EGEMO protocol, which makes it possible to effect secure multi-hop transport of EAP authentication packets above layer 2 of the OSI (Open Systems Interconnection) model. The transport technique developed by the EGEMO protocol is based on opportunistic and geographical routing and broadcasting of EAP packets as described in the document ‘Performance Analysis of a Layer-2 Multi-Hop Authentication and Credential Delivery Scheme for Vehicular Networks’. The EGEMO protocol is stateless because it is not based on routing tables. This property of the EGEMO protocol is particularly suited to highly dynamic networks.

FIG. 5 shows the principal steps of an authentication method of one implementation of the present invention. In a step 50, a counter, preferably managed at the level of an authentication server of the access network 11, indicates a number of authentication requests already received either at the authentication server level or at the overall level of the access network 11. To this end there is therefore provision for incrementing this counter by 1 on reception of each authentication request. There may be provision for regularly resetting this counter to 0 to implement an authentication method of one implementation of the invention that is flexible and suited to evolutions of the density of the network over time.

In a step 51, the authentication server receives an authentication request from said mobile terminal. The counter is therefore incremented by 1 in a step 52.

Then, to decide in a pertinent manner if it is preferable for the authentication function to be distributed to a mobile terminal, the value indicated by the counter is compared with a threshold value in a step 53. Whatever the result of this comparison, the mobile terminal concerned is authenticated at the level of the authentication server. However, as a function of the result of this comparison, in a step 55, it is decided whether or not to authorize this mobile terminal to authenticate other mobile terminals subsequently. To be more precise, if the value indicated by the counter is greater than the threshold value, the decision is taken to authorize the authenticated mobile terminal to authenticate other mobile terminals subsequently.

This approach makes it possible to guarantee a level of availability of access to the resources and services offered in the network, even in a context of high mobile terminal mobility, since this kind of authentication method is flexible in time and may be adapted as a function of the variations in the density of the mobile terminals.

Here the authentication function is distributed over one or more mobile terminals by the authentication server. As a security measure, only a mobile terminal already authenticated may be authorized to authenticate another mobile terminal subsequently.

It should be noted that when a mobile terminal is authenticated by another mobile terminal when the two mobile terminals are geographically close together, the propagation time of message traffic linked to this authentication is limited. This contributes to guaranteeing a certain level of authentication performance, particularly with a high density of vehicles.

FIG. 6 shows the use of the various protocol layers in a vehicular network of one implementation of the present invention.

This network includes two OBUs 14 and one OBU 61 that is in the process of authentication by the access network, from which, in one implementation of the present invention, it receives the authorization to authenticate other OBUs of the network. This network also includes an access point 13 and an authentication server 12.

The protocol stack used at the level of the OBU 61 includes a DSRC MAC layer 601, an EGEMO layer 602, an EAP layer 603, and an AUCRED layer 604.

The protocol stack used at the level of the OBUs 14 includes a DSRC MAC layer 601 and an EGEMO layer 602, and also layers 603 and 604 not shown here.

In one implementation of the present invention, two protocol stacks are used at the access point level, one for wireless communication and one for cable communication. The protocol stack for wireless communication includes a DSR MAC layer 601, an EGEMO layer 602, and an EAP layer 607. The protocol stack for cable communication includes an 802.3 MAC layer 614, an IP layer 615, a UDP layer 616, a Radius or Diameter layer 606, and an EAP layer 607. Here the transition of a packet from the wireless network to the cable network and vice-versa are effected via the EAP layer 607 common to the two stacks.

Finally, at the authentication server level, a protocol stack includes an 802.3 MAC layer 608, an IP layer 609, a UDP layer 610, a Radius/Diameter layer 611, an EAP layer 612, and an AUCRED layer 611.

In one implementation, an authentication server authorizes an OBU, on the occasion of its authentication or re-authentication, to act as an authentication server if a certain threshold is exceeded in terms of the number of authentication requests. To be more precise, the OBU is granted the privileges of the authentication server if the number of authentication (or re-authentication) requests received by the authentication server over a given time period, called the observation period, exceeds the number of authentication requests that the authentication server would have received for a particular density of mobile terminals.

The authentication success rates begin to drop off when the distance between mobile terminals, or inter-vehicle distance for a vehicular network, which reflects a density of vehicles in the network, is below a minimum distance first threshold value Idₘᵢₙ₁ satisfying the following equation:

Idₘᵢₙ₁=R/(2)^{(2*InterAPDist-10R)/10R} (1)

in which R is the transmission range of the mobile terminals in the network and InterAPDist is an average distance between the different access points in the network.

Moreover, delays in executing authentication become too great if an inter-vehicle distance in the network is below a minimum threshold second value Idₘᵢₙ₂ satisfying the following equation:

Idₘᵢₙ₂=¾*R (2)

In this context, a limit vehicle density could correspond to an inter-vehicle distance equal to the lower or the higher of these two minimum threshold values.

The limit density may also be considered to correspond to a median inter-vehicle distance Id_{med} i.e. one satisfying the following equation:

Id_{med}=(Idₘᵢₙ₁+Idₘᵢₙ₂)/2 (3)

Moreover, in one implementation of the present invention, each access point or RSU 13 updates a first counter indicating the number of packets in transit through it, using the EGEMO protocol, for example, and a second counter indicating a sum of corresponding speeds, i.e. the sum of the speed values that are indicated in each of these packets.

These first and second counters are updated over a given time period. Each access point 13 then, at the end of the observation period, sends the authentication server 12 the values indicated in the first and second counters. Thus the authentication server regularly receives the number of EGEMO-type packets received by all the access points that correspond to it, as well as the sum of the corresponding speeds.

Thus the following steps are executed in an access point 13:
on reception of each packet received, incrementing by 1 the packet counter and incrementing the speed counter with the speed value indicated in said received packet, which speed value may be indicated in the field 36 of the message shown in FIG. 3;
initializing the two counters to 0 at the beginning of each observation period; and
sending the values indicated by the two counters to the authentication server at the end of each observation period.

To effect this last step, the values of the two counters may be sent from an access point to the authentication server in a RADIUS or Diameter packet.

Accordingly, at the end of each observation period, the authentication server receives from all the access points communicating with it the number of packets, of EGEMO type, for example, that they have received and the sum of the corresponding speeds. The authentication server can thus calculate the average speed of the mobile terminals or vehicles in the network and deduce therefrom an authentication request threshold value that, in one implementation of the present invention, corresponds to a predetermined limit vehicle density.

This limit vehicle density may correspond pertinently to an average inter-vehicle distance threshold in the vehicular network.

This authentication request threshold value may satisfy the following equation:

V_{threshold}=(D×V_{avg})/Id (4)

in which Id is a threshold inter-vehicle distance, which may for example satisfy one of the above equations (1), (2) or (3), V_{avg} is the average speed of the vehicles in the network, and D is the observation period or given time period.

The authentication server is able to decide, on the basis of the threshold value V_{threshold} determined in this way, whether or not to distribute the authentication function to one or more mobile terminals. Thus on the occasion of authenticating a mobile terminal, and before generating parameters or attributes of the temporary certificates in the AUCRED message m6, the authentication server compares the number of authentication requests actually measured over the last observation period to the calculated authentication request threshold value V_{threshold} corresponding to the same time period.

If the number of authentication requests counted at the authentication server level is greater than the calculated threshold value V_{threshold} the authentication server decides to assign the authentication server role to the mobile terminal that is being authenticated. In one implementation of the present invention, this decision is notified to the mobile terminal concerned in the attributes of the temporary certificates that the server sends to the mobile terminal. Following this authentication, the mobile terminal has temporary certificates signed by the authentication server granting it the privilege of carrying out authentication.

At the authentication server level, for any EAP packet received via RADIUS or Diameter, for example from an access point and corresponding to an authentication or re-authentication request, the request counter is updated by incrementing it by 1. This counter is reset to 0 at the end or the beginning of the observation period.

At the end of the observation period, the authentication server receives from all the access points with which it communicates the number of EGEMO packets that each of these access points has received and the cumulative speeds relating to those packets.

On the basis of the above information, the authentication server is able to calculate an average speed V_{avg} of the mobile terminals of the network from the following equation:

$${V}_{avg} = {\sum }_{i = 1}^{n} {cpt}_{1 , i} / {\sum }_{i = 1}^{n} {cpt}_{2 , i}$$

where cpt_{1,i} is the value indicated by the first counter and sent by the access point i and where cpt_{2,i} is the value indicated by the second counter and sent by the access point I, for i between 1 and n, where n is the number of access points 13 with which the access network communicates.

V_{threshold} is then determined from equation (4).

It is then decided, as described above, to authorize the mobile terminal that is being authenticated subsequently to authenticate other terminals itself.

A mobile terminal authorized to assume the authentication server role may then respond directly to another mobile terminal from which it receives an authentication request and effect that authentication instead of the authentication server. In this context, there is provision for a mobile terminal to accept authentication by another mobile terminal only if the said terminal shows it temporary certificates with attributes that confer the required privileges, those attributes having been entered into the message m6 and the temporary certificates associated with those attributes received in the message m8.

The authentication server can thus distribute its functions until the number of authentication requests received falls below the threshold value V_{threshold}. Thereafter, the mobile terminals elected in this way to the authentication server role retain that role temporarily, for example until their next authentication or re-authentication, during which the authentication server takes the new conditions into account to decide whether or not to distribute its role as described above.

Thus the distribution of the authentication function remains temporary. There may be provision for it to be effective during a period of validity of the temporary certificates that confer this privilege.

In one implementation of the present invention there is provision for smoothing the value of the counter of the number of authentication requests and the threshold value V_{threshold} to take account of the corresponding values in preceding observation times. This approach makes it possible to weight the evolution of these values and thus to prevent too great a variation of the values thus measured or calculated from one observation period to another. Under such circumstances, there may be provision, at the end of each observation period, for a value V, whether it is a measured value like the counter cpt_{1,i} or cpt_{2,i} or a calculated value like the threshold value V_{threshold} to be weighted as follows:

V=α×V_{new}+(1−α)×V_{old}

in where α is a weighting factor strictly between 0 and 1, V_{new} is the calculated or measured value considered over the observation period that has just elapsed; and
V_{old} is the calculated or measured value considered over the observation period preceding that which has just elapsed.

FIG. 7 shows a server 12, an access point 13, and a mobile terminal 14 of one embodiment of the present invention.

The authentication server 12 includes:
a counter 701 for indicating a number of authentication requests received;
a receiver unit 702 for receiving an authentication request from the mobile terminal;
a comparator unit 703 for comparing the number indicated by the counter with a threshold value; and
an authentication unit 704 for authenticating the mobile terminal and deciding, on the basis of the comparison effected by the comparator unit, to authorize the authenticated mobile terminal to exercise the authentication role to authenticate another mobile terminal.

The authentication server may further include a determination unit 705 adapted to determine the threshold value over a given time period as a function of a threshold average distance between two mobile terminals of the network and an average speed of the mobile terminals in the network.

A mobile terminal 14 of one embodiment of the present invention includes:
a sender unit 710 for sending an authentication request to the access network;
a receiver unit 711 for receiving an authentication message indicating parameters for authenticating another mobile terminal; and
an authentication unit 712 for playing the access network role to authenticate another mobile terminal.

An access point 13 to an access network of one embodiment of the present invention includes:
a first counter 720 for indicating a number of packets received;
a second counter 721 for indicating a sum of the speeds of the mobile terminals indicated in said received packets; and
a sender unit 722 for sending the access network the values indicated in the first and second counters at the end of a given time period.

By means of the features described here, it is possible to manage the availability of authentication and consequently of access to the resources and services of the network in a pertinent manner so as to increase the authentication success rate and significantly reduce authentication delays, in particular with high vehicle density.

Moreover, by delocalizing the authentication step in this way, it is possible to reduce the propagation time of the traffic relating to this authentication and thereby to increase the bit rate available in the network.

An embodiment of the present invention may advantageously be implemented in both hybrid ad hoc networks and networks that are not ad hoc networks.

It is a simple matter to implement such a method of providing centralized services other than authentication.

1. A method of authenticating at least one mobile terminal in a packet transmission mobile network comprising an access network for authenticating said mobile terminal, at least one access point to said access network, and a counter for indicating a number of authentication requests already received, said method comprising the following steps executed in said access network:
1) receiving an authentication request from said mobile terminal;
2) incrementing the counter by one; and
3) authenticating the mobile terminal, comparing the number indicated by the counter with a threshold value, and, on the basis of said comparison, deciding whether to authorize the authenticated mobile terminal to assume a role of the access network to authenticate at least one other mobile terminal.

2. The authentication method according to claim 1, wherein over a given time period the threshold value is determined as a function of a threshold average distance between two mobile terminals of the network and an average speed of the mobile terminals in the access network.

3. The authentication method according to claim 2, wherein the threshold value satisfies the following equation:
V_{threshold}=(D×V_{avg})/Id
where D is the given time period, V_{avg} is an average speed of the mobile terminals in the network, and Id is a threshold average distance between two mobile terminals of the network.

4. The authentication method according to claim 2, wherein the average speed is determined in the access network based on information received from said at least one access point.

5. The authentication method according to claim 4, comprising the following steps executed in said access point:
a) receiving a new packet from a mobile terminal; and
b) incrementing a first counter by one and incrementing a second counter by the speed value indicated in said new packet;
wherein the steps a) and b) are effected over the given time period, after which the number of packets indicated by the first counter and the speed value indicated by the second counter are sent to the access network.

6. The authentication method according to claim 2, wherein the threshold average distance between two mobile terminals of the network satisfies the following equation:
Id_{med}=(Idₘᵢₙ₁+Idₘᵢₙ₂)/2 (3)
where satisfies the following equation:
Idₘᵢₙ₁=R/(2)^{(2*InterAPDist-10R)/10R} (1)
where Idₘᵢₙ₂ satisfies the following equation:
Idₘᵢₙ₂=¾*R (2)
and where R is a mobile terminal transmission range; and InterAPDist is an average distance between the different access points in the network.

7. The authentication method according to claim 1, wherein a mobile terminal is authorized to authenticate another mobile terminal for a particular time period.

8. The authentication method according to claim 7, wherein at the end of the given time period first and second counters are initialized to zero.

9. A method of authenticating a mobile terminal in a packet transmission mobile network comprising an access network for authenticating said mobile terminal and at least one access point to said access network, said method comprising the following steps executed in said mobile terminal:
1) sending an authentication request to the access network; and
2) receiving an authentication message indicating parameters for assuming a role of the access network to authenticate another mobile terminal.

10. The authentication method according to claim 9, further comprising the following steps executed in the mobile terminal:
i) receiving an authentication request from another mobile terminal of the network; and
ii) authenticating said other mobile terminal on the basis of said parameters received in the authentication message from the access network.

11. A server for authenticating at least one mobile terminal in a packet transmission mobile network, said authentication server being accessible via at least one access point and comprising:
a counter for indicating a number of authentication requests received;
a receiver unit for receiving an authentication request from the mobile terminal;
a comparator unit for comparing the number indicated by the counter with a threshold value; and
an authentication unit for authenticating the mobile terminal and deciding, on the basis of the comparison effected by the comparator unit, to authorize the authenticated mobile terminal to exercise the authentication role to authenticate another mobile terminal.

12. The authentication server according to claim 11, further comprising a determination unit for determining the threshold value over a given time period as a function of a threshold average distance between two mobile terminals of the network and an average speed of the mobile terminals in the network.

13. A mobile terminal adapted to communicate in a packet transmission mobile network comprising an access network responsible for authenticating said mobile terminal and at least one access point to said access network, said terminal comprising:
a sender unit for sending an authentication request to the access network;
a receiver unit for receiving an authentication message indicating parameters for authenticating another mobile terminal; and
an authentication unit for assuming an access network role to authenticate another mobile terminal.

14. A system for authenticating at least one terminal in a packet transmission mobile network comprising an access network responsible for authenticating said mobile terminal, said authentication system comprising at least one authentication server according to claim 11 and an access point to said access network, said access point comprising:
a first counter for indicating a number of packets received;
a second counter for indicating a sum of the speeds of the mobile terminals indicated in said received packets; and
a sender unit for sending the access network the values indicated in the first and second counters at the end of a given time period.

15. A non-transitory computer-readable storage medium storing a computer program comprising instructions for executing the method according to claim 1 when the program is executed by a processor.
